(19) United States
(12) Patent Application Publication
(10) Pub. No.: US 2024/0179652 A1
(43) Pub. Date: May 30, 2024

(54) Time-synchronized sound reproduction installation

(71) Applicant: DEVIALET, Paris (FR)

(72) Inventors: Adrien CHARRUEL, Vincennes (FR); Pierre-Emmanuel CALMEL, Le Chesnay (FR); Romain DÉJARDIN, Colombes (FR)

(21) Appl. No.: 18/553,319

(22) PCT Filed: Mar. 31, 2022
(86) PCT No.: PCT/EP2022/058698

§ 371 Date: Sep. 29, 2023

(30) Foreign Application Priority Data
Mar. 31, 2021 (FR) 21 03356

(51) Int. Cl. H04W 56/00; H04R 3/12

(52) U.S. Cl. CPC H04W 56/002; H04R 3/12; H04R 2420/07

(57) ABSTRACT

The sound reproduction installation (10) includes sound reproduction equipment (12, 14), each comprising:
an internal clock (22);
means (20) for receiving synchronization time information;
means (30) for receiving an audio stream to be reproduced, including time reproduction information; and
means (52) for audio reproduction of the audio stream on the basis of the internal clock (22).

The means (20) for receiving time synchronization information are able to receive the TSF signals from a single Wi-Fi network (16) having a single BSSID address for all the equipment (12, 14), and each piece of equipment (12, 14) includes means (26) for slaving the internal clock (22) to the TSF signal received.

The present invention relates to a sound reproduction installation, of the type including at least two sound reproduction devices, each device including:
an internal clock;
means for receiving time-synchronization information; and
means for receiving an audio stream to be reproduced, including time reproduction information; and
means for audio reproduction of the audio stream on the basis of the internal clock (22).

It is known to allow the same audio stream to be broadcast from several pieces of sound reproduction equipment receiving the same audio stream. The audio stream to be reproduced includes time reproduction information indicating to each piece of equipment at what instant the samples constituting the sound stream are to be reproduced.

To this end, each piece of equipment includes an internal clock defining a local time base specific to the piece of equipment. To ensure simultaneous reproduction of the audio stream samples identified by the same time reproduction information, the internal clocks need to be synchronized to the same time base.

The internal clocks of the various pieces of equipment are not strictly equal in frequency, and their initialization offset must be taken into account in order to synchronize them.

To this end, it is known to establish an exchange of time synchronized information between the audio equipment. In particular, these devices exchange their initial time offset, or phase shift, in order to take account of their own offset relative to the time reproduction information associated with the audio stream.

These solutions are described, for example, in U.S. Pat. Nos. 10,296,183, 10,175,930, 10,185,540, 10,185,541, 10,209,953, and 10,303,432.

According to the IEEE1394 standard, the local clocks of each piece of equipment are synchronized on the basis of common events external to the piece of equipment and originating from the network. These correspond to the 125 us cycles (8000 cycles per second) used for time-division multiplexing implemented.

Each piece of equipment manages an internal clock, with the CYCLE_TIME register serving as the time base. These registers are updated every 125 us cycle, and between two cycles, these registers are incremented independently in each piece of equipment.

The audio stream samples to be reproduced are addressed isochronously in the different 125 us time slots, without adding time reproduction information. The time reproduction information of the audio stream is therefore defined by the slot in which the samples are transmitted.

This system guarantees bandwidth for video streams, thus avoiding jerky effects and other losses of quality.

However, this system requires samples to be transmitted isochronously. However, most networks do not provide such isochronous transmission. It is therefore important to allow synchronized reproduction of the audio stream samples transmitted during reproduction, even if they are transmitted asynchronously.

The aim of the invention is to provide a solution for allowing the synchronized reproduction of audio samples in an asynchronous transmission network, while at the same time allowing synchronized reproduction of the audio samples.

To this end, the invention has as its object a sound reproduction installation of the aforementioned type, characterized in that:
the means for receiving time-synchronization information is able to receive the TSF signals of a single Wi-Fi network having a single BSSID address for all the equipment, and
each piece of equipment includes means for slaving its internal clock to the FST signal received.

In accordance with the embodiments, the installation includes one or more of the following features:
each piece of equipment includes means for verifying connection to the same Wi-Fi network with the same BSSID address;
the means for receiving the audio stream and the means for receiving time-synchronization information are suitable for receiving from different networks;
the audio stream receiving means are able to receive data from an asynchronous network;
the time reproduction information contained in the audio stream is expressed in the TSF time base;
the installation includes means for adding, to the audio stream, reproduction time information expressed in the TSF signal time base;
the means of controlling the internal clock includes a phase-locked loop to obtain a clock output signal synchronized with the TSF signal;
the installation has no means of exchanging time-synchronization information between the equipment; and
the clocks of each piece of equipment are not slaved to each other.
The invention also has as its object a method of sound reproduction in an installation including at least two pieces of sound reproduction equipment, the method including for each piece of equipment:
   generating clock signals from an internal clock;
   receiving time-synchronization information;
   receiving an audio stream to be reproduced, including time reproduction information;
   sound reproduction of the audio stream on the basis of the internal clock, characterized in that;
   receiving synchronization information comprises receiving the TSF signals from the same WIFI network having the same BSSID address for all equipment, and
   slaving the internal clock to the TSF signals received.

The invention will be better understood on reading the following description, given by way of example only and with reference to the drawings in which:

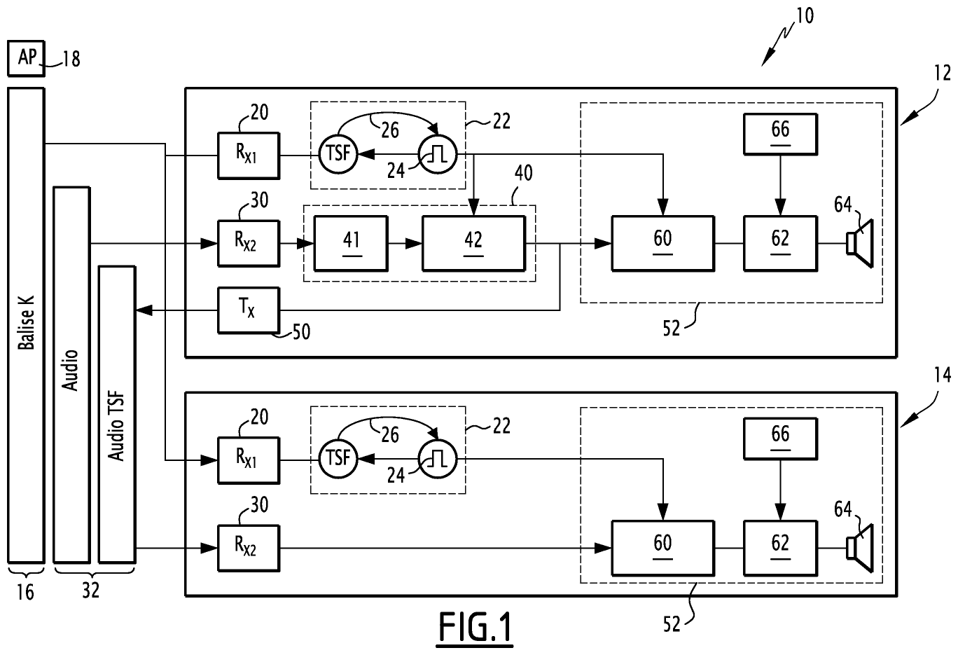

FIG. 1 is a schematic view of a sound reproduction installation according to the invention.

The sound reproduction installation 10 shown in FIG. 1 includes two pieces of sound reproduction equipment 12, 14, the equipment 12 being a master equipment and the equipment 14 a slave equipment.

These two pieces of equipment are connected to a Wi-Fi network 16 including a wireless access point 18 (WAP), or more simply AP, (Wireless) Access Point The Wi-Fi access point is identical for both pieces of equipment 12, 14 and is characterized by the same BSSID address.

Each piece of equipment 12, 14 includes an input interface 20 through which it is connected to the Wi-Fi network 16, and more precisely to the common access point 18.

These interfaces include means for ensuring a connection to the same Wi-Fi access point 18 based on the detection and verification of its unique BSSID address. The unique BSSID address is selected when the equipment is initialized when associated with the Wi-Fi network.

These input interfaces 20 are able to receive time-synchronization information and, more precisely, TSF signals transmitted regularly on the Wi-Fi network.

This time-synchronization information is transmitted in beacons from the access point 18 toward all network equipment in accordance with IEEE Std 802.11-2007, section 5.4.6.

According to this standard, each node maintains an internal synchronization clock, necessary for:
PCF mode (start of superframe) and
frequency hopping synchro (if FHSS).

To synchronize these clocks, the IEEE 802.11 standard specifies a time synchronization function (TSF).

This synchronization of stations is achieved through periodic transmissions (if channel free, otherwise deferred) of beacon frames containing:
a stamp,
the BSSID, . . .
the TSF signal, which allows the node to readjust its internal clock.

Thus, approximately every twenty-five microseconds, each piece of equipment receives common synchronization information constituted of a time defined in a common reference frame specific to the access point 18.

The time base thus defined is referred to in the following as the TSF time base.

The input interface 20 is connected to an internal clock 22 of each piece of equipment to receive the TSF information. This internal clock includes its own local time base 24 generated, for example, by a crystal. The internal clocks 22 of each piece of equipment are not slaved to each other.

This time base 24 is controlled by a control loop 26 on the TSF samples received from the interface 20. The control loop, formed for example by a phase-locked loop (PLL), allows to synchronize the instants of the local time base 24 with the TSP information received.

The clock 22 preferably comprises a digital control loop.

Furthermore, each piece of equipment 12, 14 includes an interface 30 for receiving an audio stream to be reproduced. This interface 30 is connected to an information transmission network 32, which is formed according to a first embodiment by the Wi-Fi network 16. Alternatively, the network 32 is an asynchronous information transmission network distinct from the Wi-Fi network 16, and the input interfaces 30 are adapted accordingly. This transmission network is, for example, an Ethernet or 5G network.

The audio stream is constituted of audio samples or blocks associated with audio stream structuring information allowing the audio stream to be reproduced from the samples.

In the master equipment 12, the input interface 30 is connected to a module 40 for shaping the audio stream in the TSF time base.

This module 40 includes a reader of digital audio stream 41, known as audio streamer able to segment the audio stream to be reproduced from the samples received over the network 32.

The output of the digital audio streamer is connected to a sampler 42, able to segment the audio stream to be reproduced into audio samples, each associated with time reproduction information expressed in the time base of the local clock 22 and corresponding to the TSF time base.

The output of sampler 42 forming the output of the module 10 in the master equipment 12 is connected to an output interface 50 on the one hand, and to a sound reproduction module 52 on the other.

The output interface 50 is specific to transmit to the asynchronous network 32, the sound samples and their time reproduction information, expressed in the TSF time base.

The reproduction module 52, specific to each equipment 12, 14 is connected to the input interface 30, either directly for a reproduction equipment 14, or through the signal shaping means for an equipment 12.

The reproduction means 52 includes an audio stream reconstruction module 60, which receives as input sound samples and time reproduction information in the TSF time base.

This module 60 is also connected to the internal clock 22 to receive the clock instants. It is able to reconstitute a reproducible audio stream by positioning the samples in accordance with the time reproduction information contained in the incoming samples.

The audio stream thus reconstituted is sent to the means 62 for driving a loudspeaker 64. The means 62 includes a digital-to-analog converter and amplification means. These means 62 are connected to a selector 66 defining in the audio stream the components to be reproduced. In particular, if the audio stream is stereophonic, the means 62 define the voice or voices to be reproduced by the means 62.

The installation works as follows. The access point 18 regularly broadcasts beacons on the Wi-Fi networks, which contain the TSP time synchronization information.

This information is received by the various equipment through their input interface 20. The control loop 26 of each clock ensures the control of the internal clock 22 based on the TSP time synchronization information received.

The shaping module 40 receives samples of an audio stream from the network 32 through the interface 30, and by ensuring their reconstitution in the means 41. In the time base specific to the local clock 22, which is synchronized with the TSF time base, the splitting module 42 ensures the segmenting of the reconstituted audio stream into samples, each of which is associated with a piece of time reproduced information expressed in the TSF time base.

The samples in the TSF time base are sent, either directly for the equipment 12, or by means of the network 32 for the equipment 14, to the reproduction means 52, which reconstitutes the audio stream from the time information produced by the local clocks, all of which are representative of the instants in the TSF time base. The reconstituted audio stream is then reproduced by the loudspeakers 64 under the control of the amplification means 62.

It is understood that each piece of audio equipment having a local clock 22 slaved to the same TSF signal from the Wi-Fi network, the local time of sample reproduction is identical in each piece of equipment 12, 14, thus ensuring perfect and permanent synchronization of audio stream reproduction.

Alternatively, more than one piece of the slave equipment 14 is used.

In yet another alternative, the signal shaping means 40 are provided outside one of the audio equipment, and all the audio equipment are the slave equipment of the type of equipment 14.

1. A sound reproduction installation including at least two pieces of sound reproduction equipment, each equipment comprising:
an internal clock;
means for receiving time synchronization information;
means for receiving an audio stream to be reproduced including time reproduction information; and
means for audio reproduction of the audio stream on the basis of the internal clock;
characterized in that
the means for receiving time synchronization information are able to receive TSF signals from a single Wi-Fi network having a single BSSID address for all the equipment, and
each piece of equipment includes means for slaving its internal clock to the received TSF signal to form a TSF time base, the internal clocks of each piece of equipment not being slaved to each other.

2. The installation according to claim 1, characterized in that each piece of equipment includes the means for verifying connection to the same Wi-Fi network with the same BSSID address.

3. The installation according to claim 1, characterized in that the means for receiving the audio stream and the means for receiving time synchronization information are able to receive from different networks.

4. The installation according to claim 1, characterized in that the means for receiving the audio stream are able to receive data from an asynchronous network.

5. The installation according to claim 1, characterized in that the time reproduction information contained in the audio stream is expressed in the TSF time base.

6. The installation according to claim 5, characterized in that the installation includes the means for adding, to the audio stream, time reproduction information expressed in the TSF signal time base.

7. The installation according to claim 1, characterized in that the means for controlling the internal clock includes a phase-locked loop (PLL) for obtaining a signal synchronized with the TSF signal at the output of the clock.

8. The installation according to claim 1, characterized in that the installation has no means of exchanging time synchronization information between the equipment.

9. The installation according to claim 1, characterized in that the clocks of each piece of equipment are not slaved to each other.

10. A method of sound reproduction in an installation including at least two pieces of sound reproduction equipment, the method including for each piece of equipment:
generating clock signals from an internal clock
receiving time synchronization information;
receiving an audio stream to be reproduced, including time reproduction information;
audio reproduction of the audio stream based on the internal clock, characterized in that
receiving synchronization information comprises receiving the TSF signals from the same Wi-Fi network having the same BSSID address for all equipment, and
slaving the internal clock to the TSF signals received.
